(19) United States
(12) Patent Application Publication
(10) Pub. No.: US 2007/0030679 A1
(43) Pub. Date: Feb. 8, 2007

(54) Light emitting diode display device

(76) Inventor: Chih-Jen Lee, Taipei Shien (TW)

Correspondence Address: BACON & THOMAS, PLLC, 625 SLATERS LANE, FOURTH FLOOR, ALEXANDRIA, VA, 22314, US

(21) Appl. No.: 11/515,716

(22) Filed: Sep. 6, 2006

(30) Foreign Application Priority Data
Sep. 6, 2005 (TW) 094130523
Aug. 7, 2005 (TW) 095128944

(51) Int. Cl. F21V 21/00

(52) U.S. Cl. 362/249

(57) ABSTRACT

The present invention concerns a light emitting diode display device. A plurality of pieces of long printed circuit board, several copper foil lines being etched, are erected. A plurality of led lamps straddle over the perimeter of each printed circuit board by means of soldering each led lamp's pin terminals on copper foil lines and copper wire, and which are integrated into a display device. After connected with a drive circuit, the display device may display texts or images with the drive voltage.

### FIELD OF THE INVENTION

The present invention relates to a light emitting diode display device. More specifically, the present invention is directed to numerous light emitting diode (LED) lamps which straddle or side over the edges of numerous long printed circuit boards (PCBs), the pins of LED lamps being soldered to the copper foillayer as they touch, or being soldered to thick copper wires to integrate into a LED display unit.

### BACKGROUND

The previous technology of LED display panel is comprised of numerous small panels. For example, C/A-5880 8×8 dot matrix display from Taiwan PARA Company adopts a common anod matrix LED display panel, wherein anodes of all LEDs in the same row are connected to row electrode and cathodes of all LEDs in the same column are connected to column electrode so that the images and texts are displayed on one side with monocolor. Due to the overall chip glue, the thickness can reach 0.35 inch. Additionally, the appearance size and the display principle of a multicolor LED display panel are identical to the said monocolor one. However, two or three different LED chips are disposed at each pixel luminous point. The previous LED display panel can only display texts and images on single surface. The construction for installation of such information board is tough and expensive. In case there has some fault at the pixel luminous point of the previous LED device, it is impossible to replace LED at such defective pixel luminous point. Additionally, the previous device can only perform the plane display, but not for the bend plane display. Hereby, for above limitations, single-surface or double-surface LED display device is developed, characteristically of low cost, easy elimination of failures and convenient construction.

### SUMMARY

The present invention is to adopt a plurality of pieces of long printed circuit boards (PCBs) with proper width and flexibility, each long PCB's copper foillayer being etched into copper foil tapes, lines or rectangles. Numerous LED lamps straddle over or side over the edges of long PCBs, and which pins at different surfaces means straddling, at the same surface means siding. LED lamp pins are connected with and soldered to the copper foil. Integrating said numerous LED lamps mounted on said multiple long PCBs are shaped into a LED dot matrix array, texts, figures or images. With dot matrix array, the LED display device adopts upright and parallel arrangement of the faces of multiple long PCBs (assume m pieces) which copper foillayers etched into line shape, tape shape or rectangle shape. Multiple LED lamps (assume n lamps) straddle or side over the edges of upright long PCBs. Each LED lamp pins are soldered to the copper foil surface which the said pins are contiguous, so that n LED lamps are lined in columns. Therefore, m×n LED lamps are rowed in dot matrix. Column electrode is produced on each PCB with long thin copper foil tapes. LED lamps in the same column of m×n LED lamps solder with the identical property LED lamp pins to generate the column electrode. The long thin metal rod (thick rod wire) to generate the row electrodes are soldered to the copper foil, transferred to the long thin copper foil of PCB so that row and column electrodes are lined parallelly. In this way, it can be connected with the drive circuit easily. One-surface copper foillayer or double-surface copper foillayer are selected for long PCBs, the monocolor luminescence or the two fundamental colors luminescence selected for LED lamps. The monocolor LED lamp with anode-cathode pins is installed on long PCB, 2 pins soldered in siding way at the same side or in straddling way at two sides. And the two fundamental colors LED lamp with 3 pins is installed on PCB, 3 pins soldered in siding way preferential. The driving method of each LED lamp is identical to the commercial LED dot matrix array panel in the prior art as follows: separate and periodic scan for all row electrodes (or column electrodes) to select the voltage. Additionally, all column electrodes (or row electrodes) are transferred to the potential signals to display texts, images and figures corresponding to LED lamp lightup, then integrated with the said time division scan. Hereby, the present invention can address any LED lamp to display any text and image. Numerous pixels are produced from the cross of row and column electrodes of long thin metal rods and the said long PCBs. A single-surface display device is developed with the single-edge installation of LED lamps and a double-surface display device is developed with the double-edge installation of LED lamps. In case specific text and image are required, then LED lamp is installed at partial pixel points. Furthermore, long PCBs may be bent in words or patterns due to its proper width and excellent reelability. Numerous LED lamps straddle over the edges of PCB, LED lamp pins connected with and soldered to the surface of the copper foil. Finally, the device may display texts and images with the drive voltage.

### BRIEF DESCRIPTION OF THE DRAWINGS

FIG. 1(A) is a stereogram view, a planform view, a side elevation view and equivalent circuit diagram of the monocolor LED lamp with 2 pins shaped in cube;

FIG. 1(B) is a planform view, side elevation view and equivalent circuit diagram of the two fundamental colors LED lamp with 2 pins shaped in cube;

FIG. 1(C) is a planform view, side elevation view and equivalent circuit diagram of the two fundamental colors LED lamp with 3 pins shaped in cube;

FIG. 1(D) is a planform view, 2 side elevation views and equivalent circuit diagram of LED Light Bar with 2 pins shaped in cube;

FIGS. 2(A) 2(B) 2(C) 2(D) are a stereogram view, planform views, side elevation views and equivalent circuit diagrams of the monocolor LED lamp with 2 pins, the two fundamental colors LED lamp with 2 pins and 3 pins, and the three fundamental colors LED lamp with 4 pins, which all are shaped in cylinder;

FIG. 3 is a schematic plan view of the monocolor LED lamps mounted on partial pixel points shaped in “LEE”;

FIG. 4 is a schematic plan view of the monocolor LED lamps mounted all partial pixel points shaped in LED dot matrix array;

FIG. 5 is a perspective view of LED dot matrix array;

FIG. 6 is a perspective view of LED dot matrix array for assembling;

FIG. 7 is a perspective view of LED dot matrix array in reversed side;

FIGS. 8(A) 8(B) are an assembly stereogram and an equivalent circuit diagram of single-surface monocolor display of another embodiment;

FIGS. 9(A) 9(B) are an assembly stereogram and an equivalent circuit diagram of the embodiment for double-surface monocolor display;

FIG. 10 is a perspective view for assembly of the first embodiment for single-surface two fundamental colors display;

FIG. 11 is a perspective view for assembly of the second embodiment for single-surface two fundamental colors display;

FIG. 12 is a perspective view for assembly of the embodiment for double-surface two fundamental colors display;

FIG. 13 is an equivalent circuit of the embodiment shown in FIG. 12;

FIG. 14 is timing diagram of the drive voltage to drive the equivalent circuit shown in FIG. 13;

FIG. 15 is a stereogram view of the embodiment for the curved surface monocolor display;

FIG. 16 is a stereogram view of the first embodiment for display of the fixed text;

FIG. 17 is an equivalent circuit diagram of the first embodiment for display of the fixed text;

FIG. 18 is the timing diagram to drive the equivalent circuit of the first embodiment for display of the fixed text;

FIG. 19 is a schematic plan view of the second embodiment for display of the fixed text shaped “US”;

FIG. 20 is an equivalent circuit diagram of the second embodiment for display of the fixed text shaped “US”;

FIG. 21 is an assembly stereogram view of the second embodiment for display of the fixed text shaped “US”;

FIG. 22 is a stereogram view of the third embodiment for display of the fixed words shaped in “OPEN”;

FIG. 23 is an assembly stereogram view of the third embodiment for display of the fixed words shaped in “OPEN”;

FIG. 24 is a stereogram view of the fourth embodiment for display of the fixed words in “OPEN”;

FIGS. 25, 26 and 27 are a planform, a partial stereogram and an equivalent circuit diagram of the embodiment for display of the fixed word of “TW” with dot matrix voltage driving;

FIG. 28 is a stereogram view of a first baton of the embodiment;

FIG. 29(A) is a stereogram view of a second baton of the embodiment;

FIG. 29(B) is a stereogram view of the second baton of the embodiment for lightup and display;

FIG. 30(A) is a stereogram view of a third baton of the embodiment;

FIG. 30(B) 30(C) are two stereogram views of the third baton of the embodiment for part LED lamps lightup and all LED lamps lightup.

### DESCRIPTION

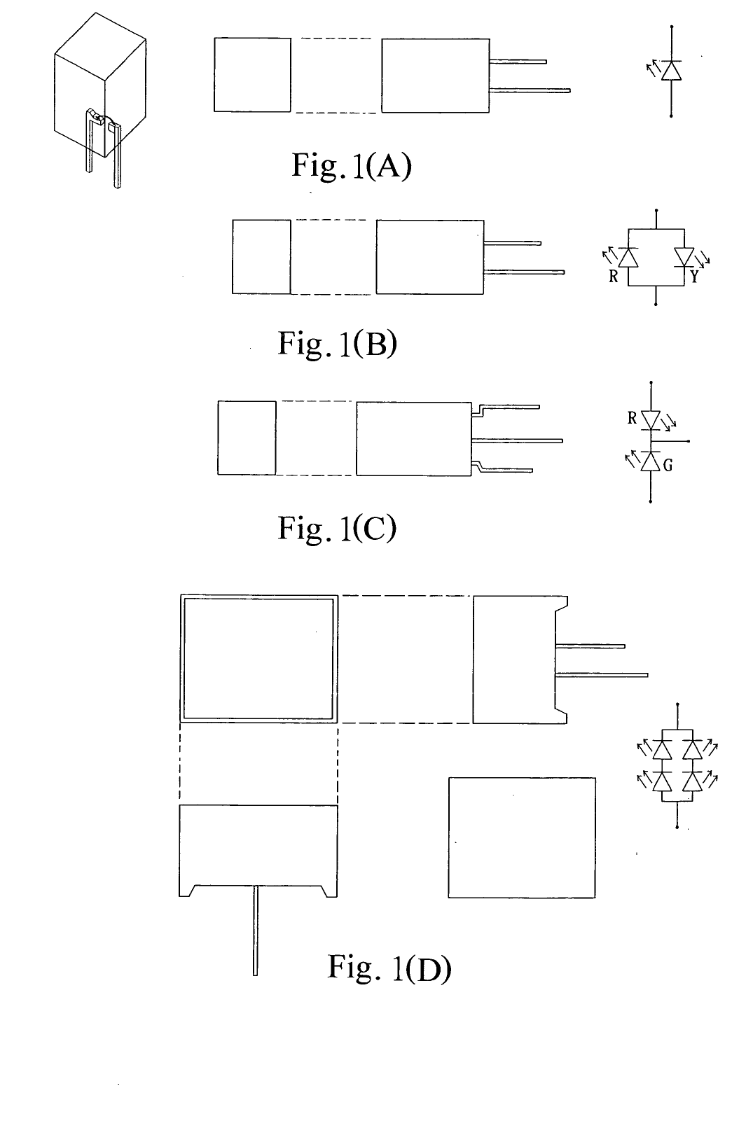

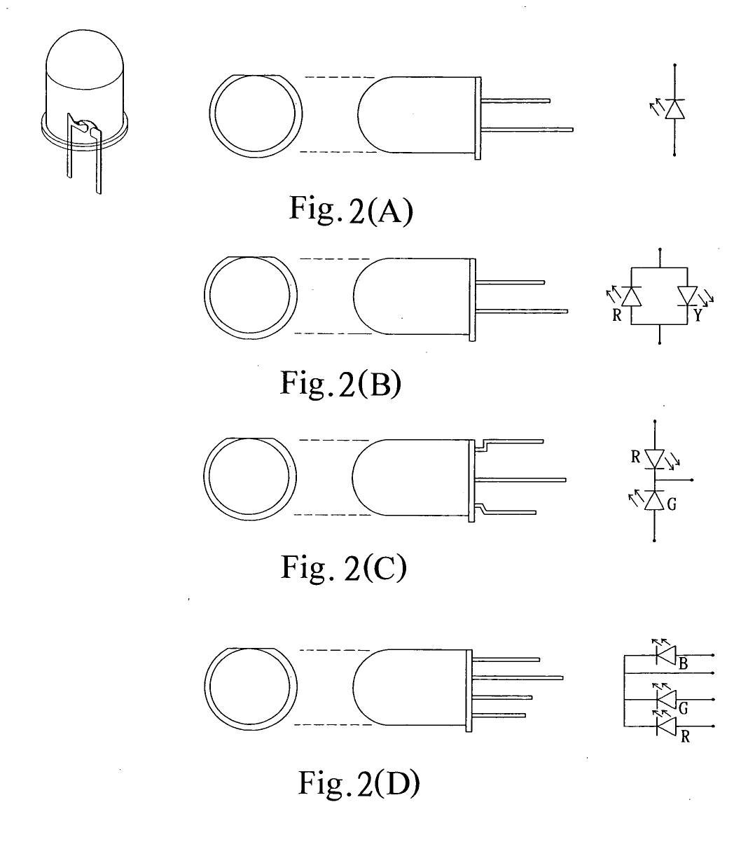

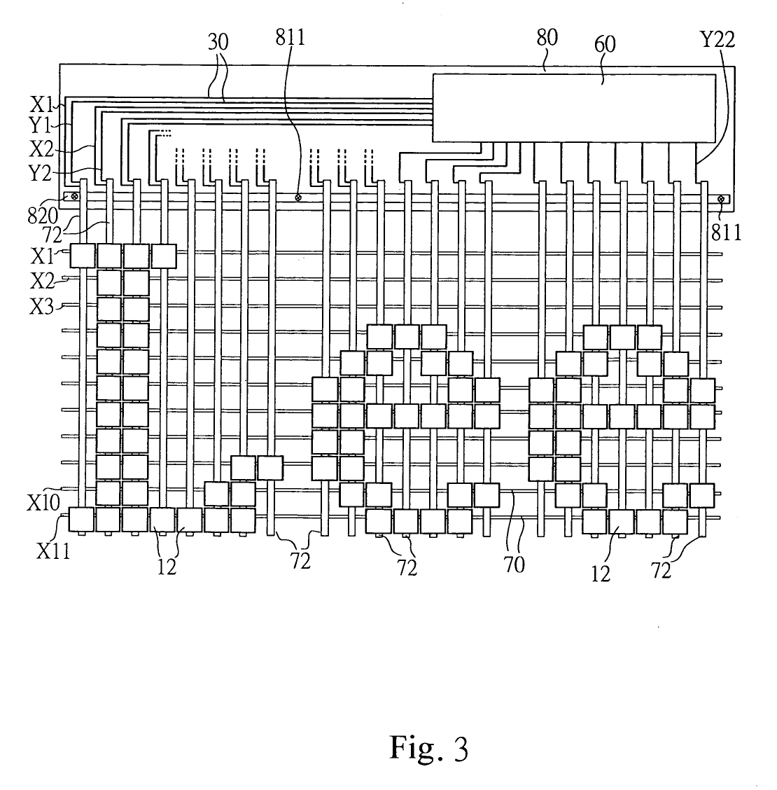

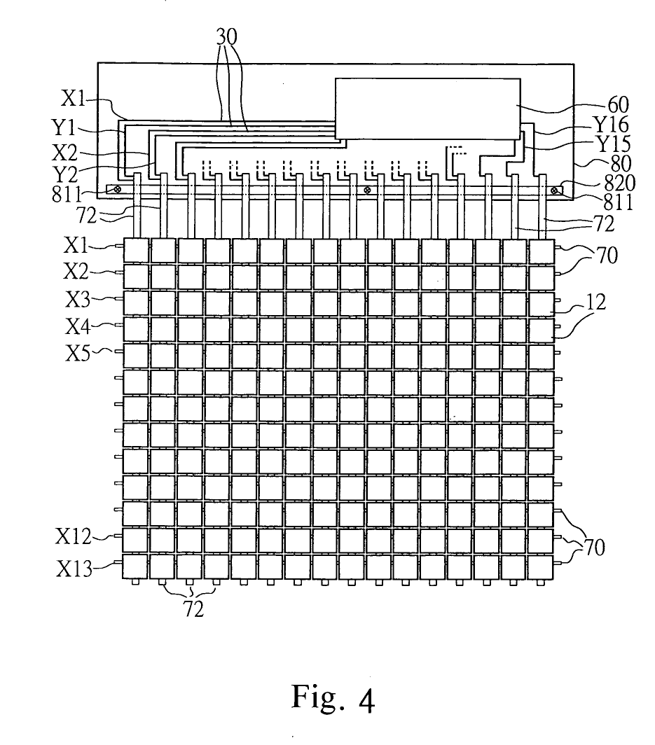

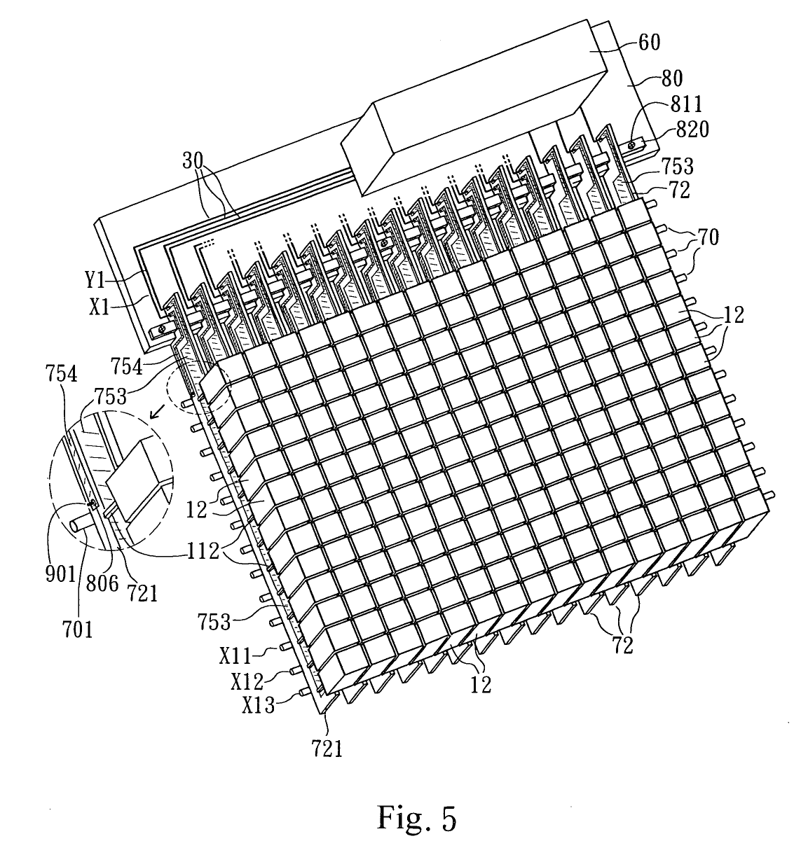

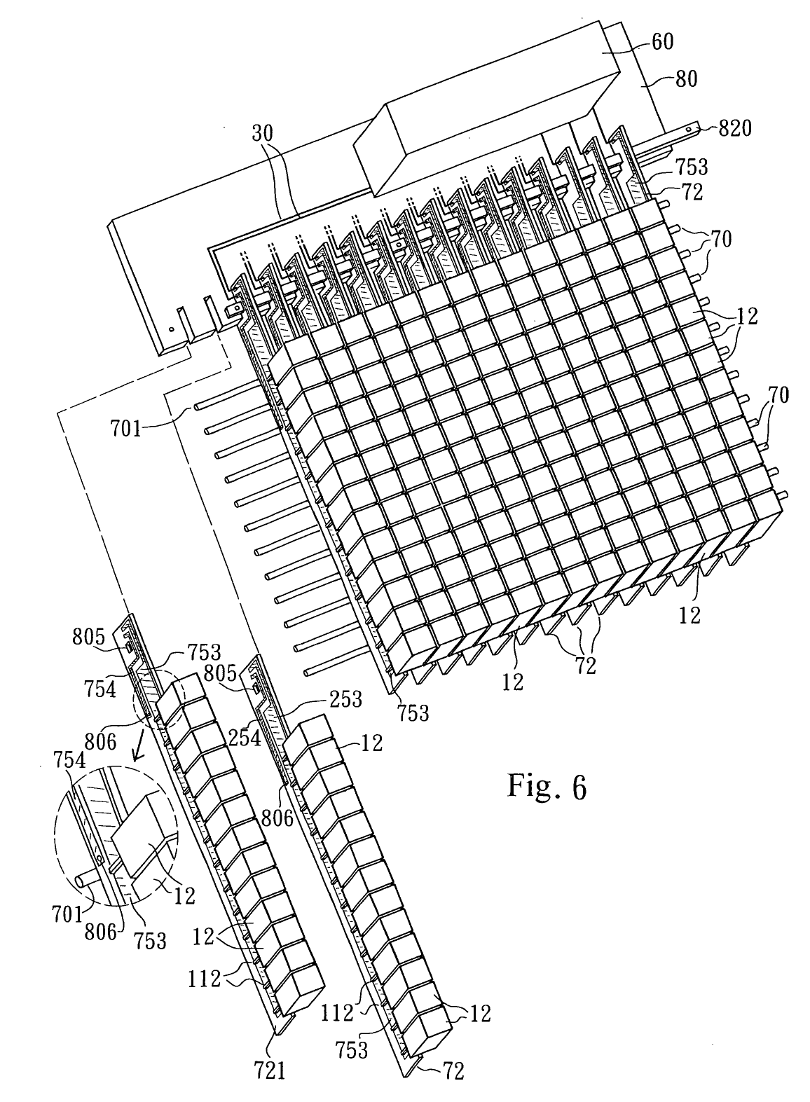

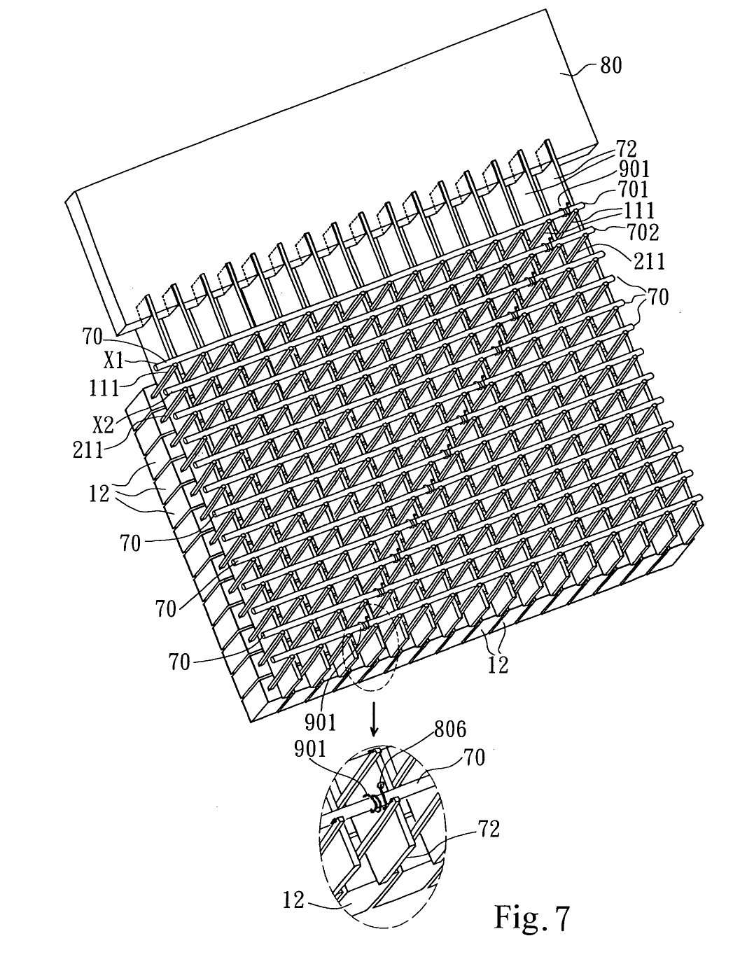

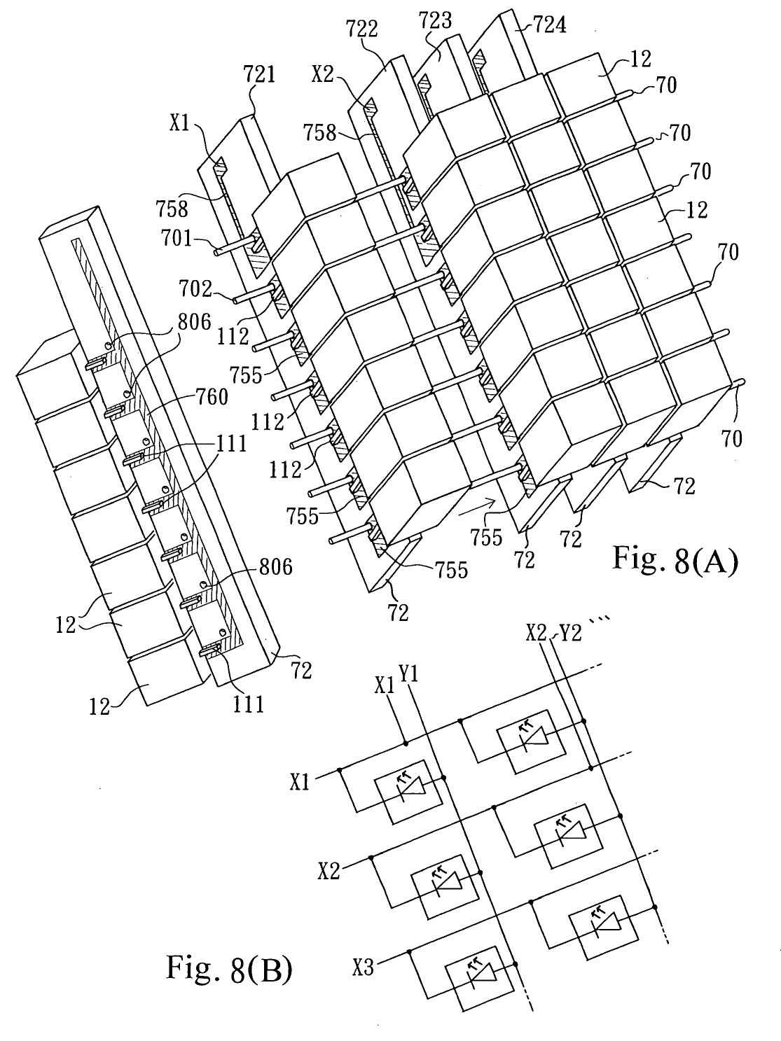

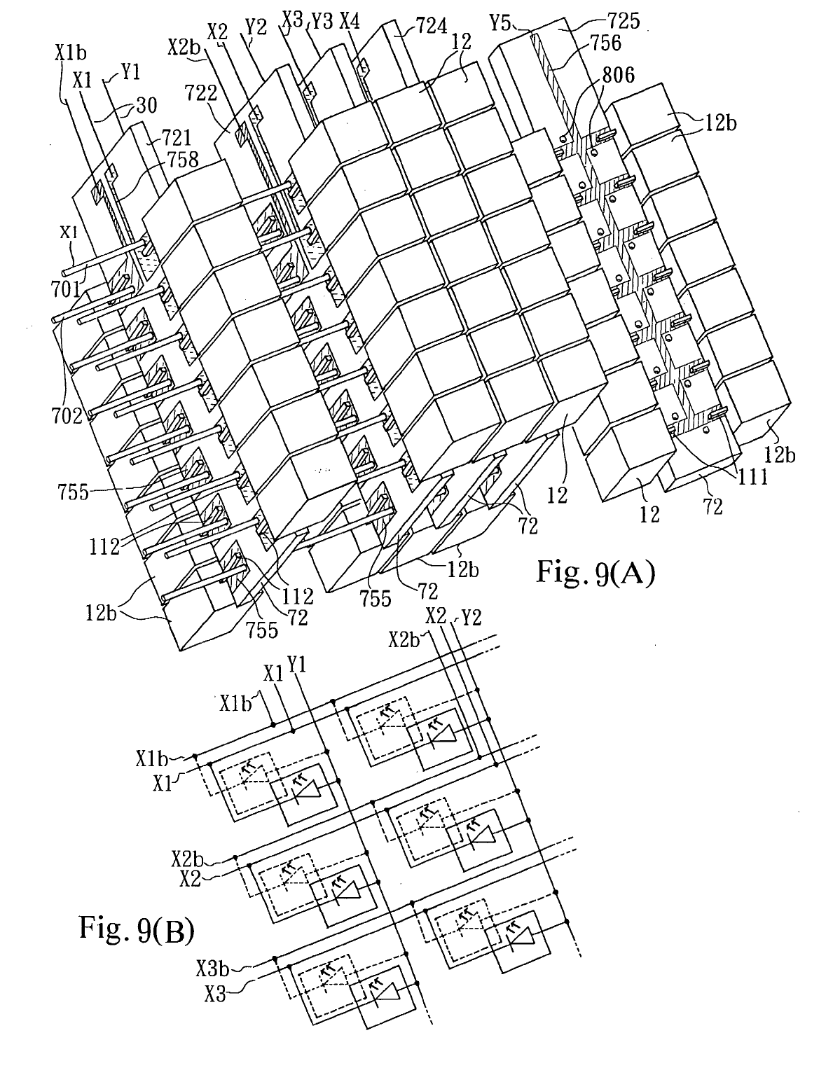

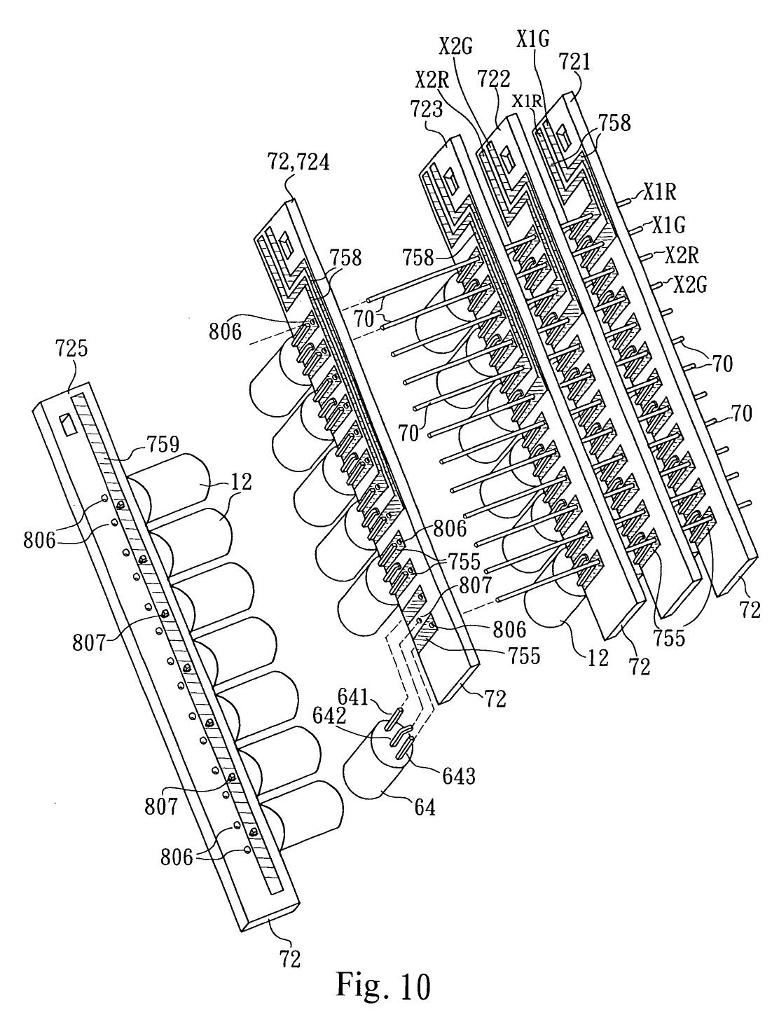

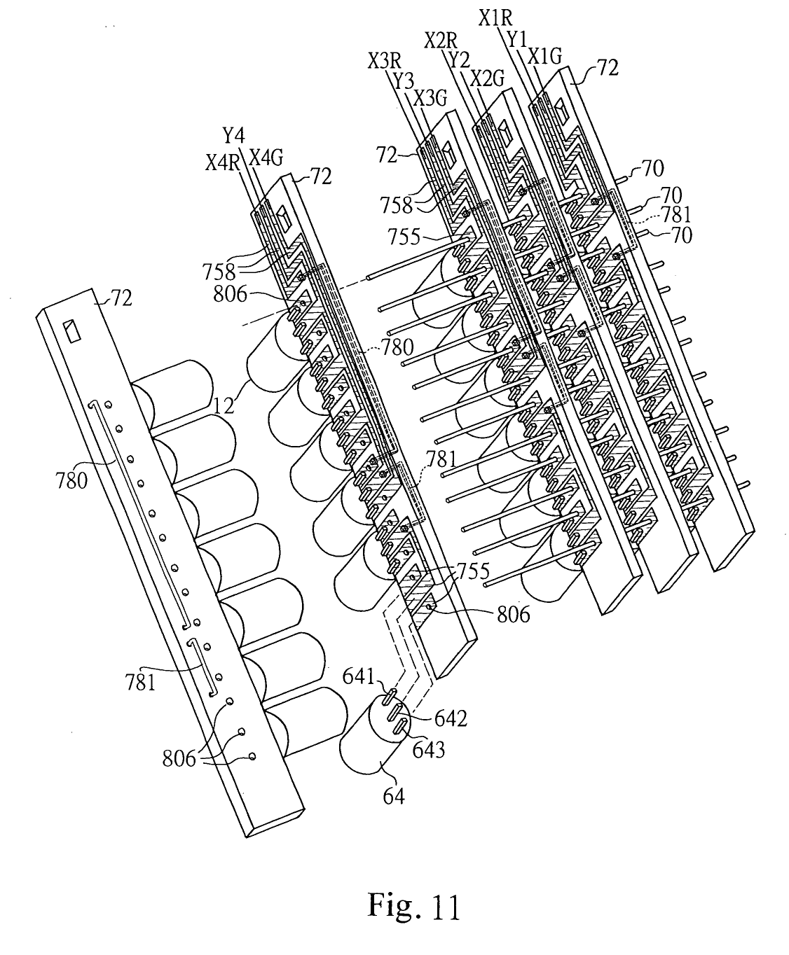

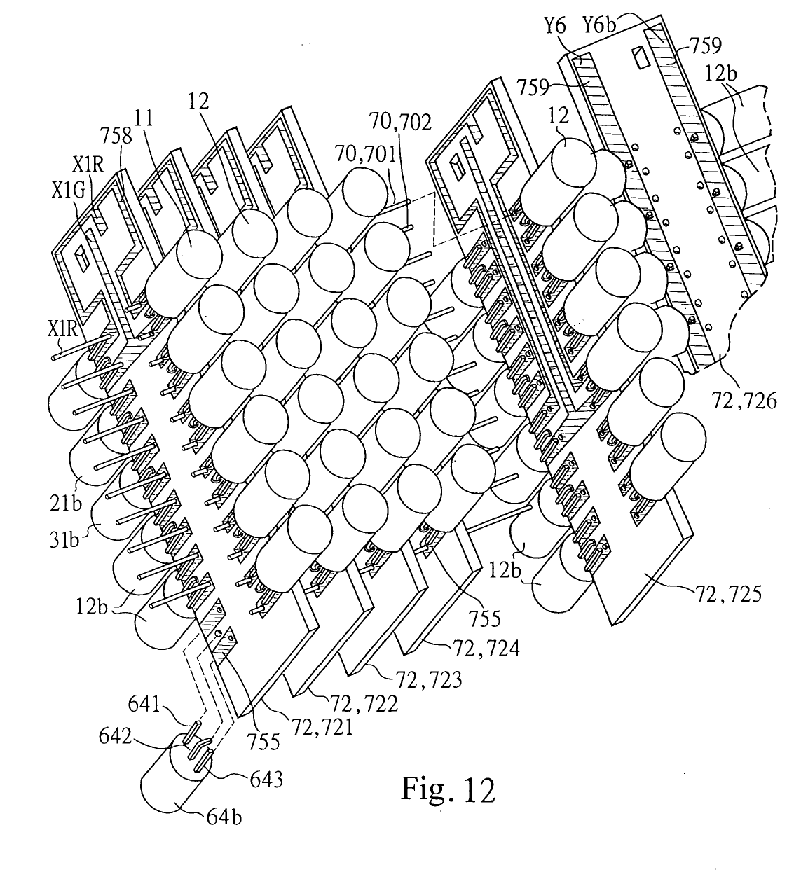

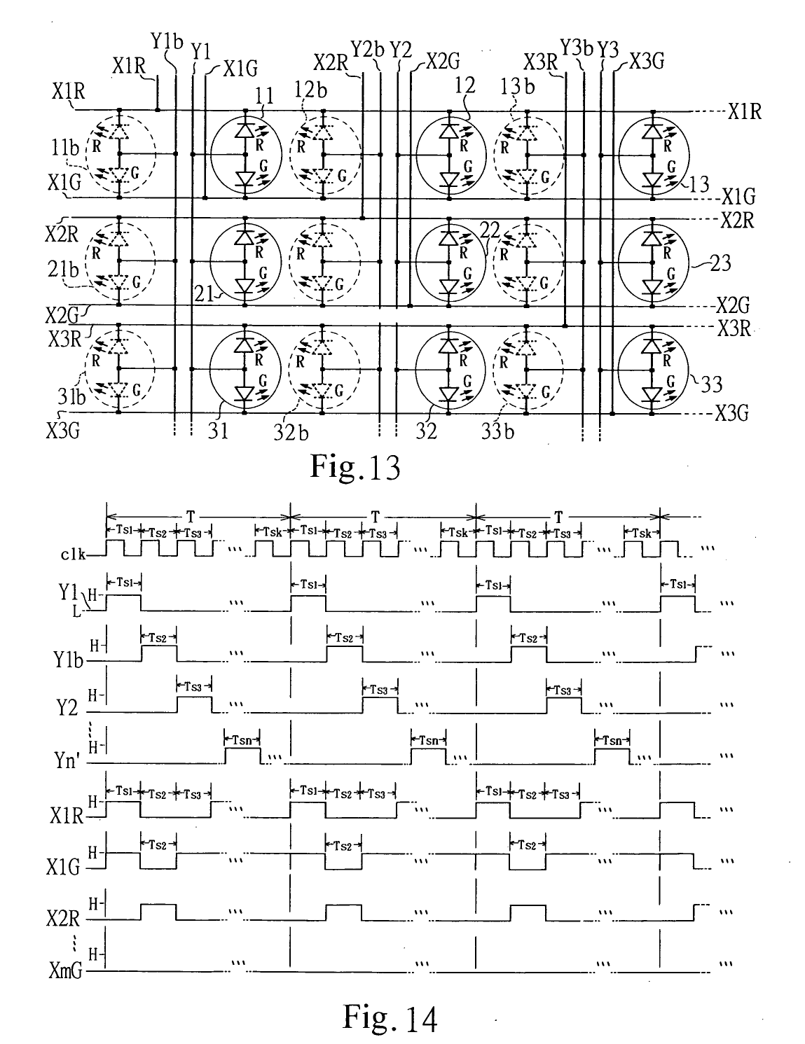

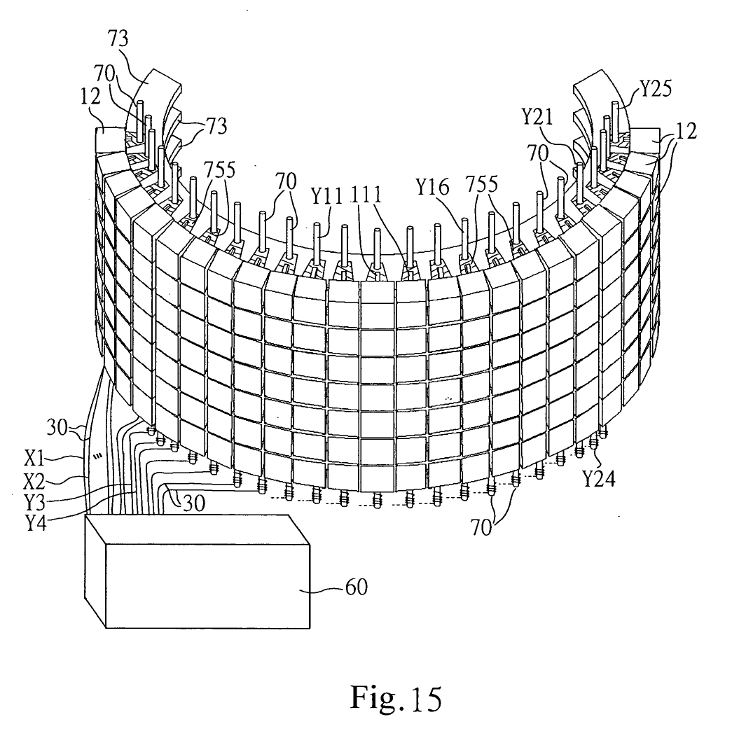

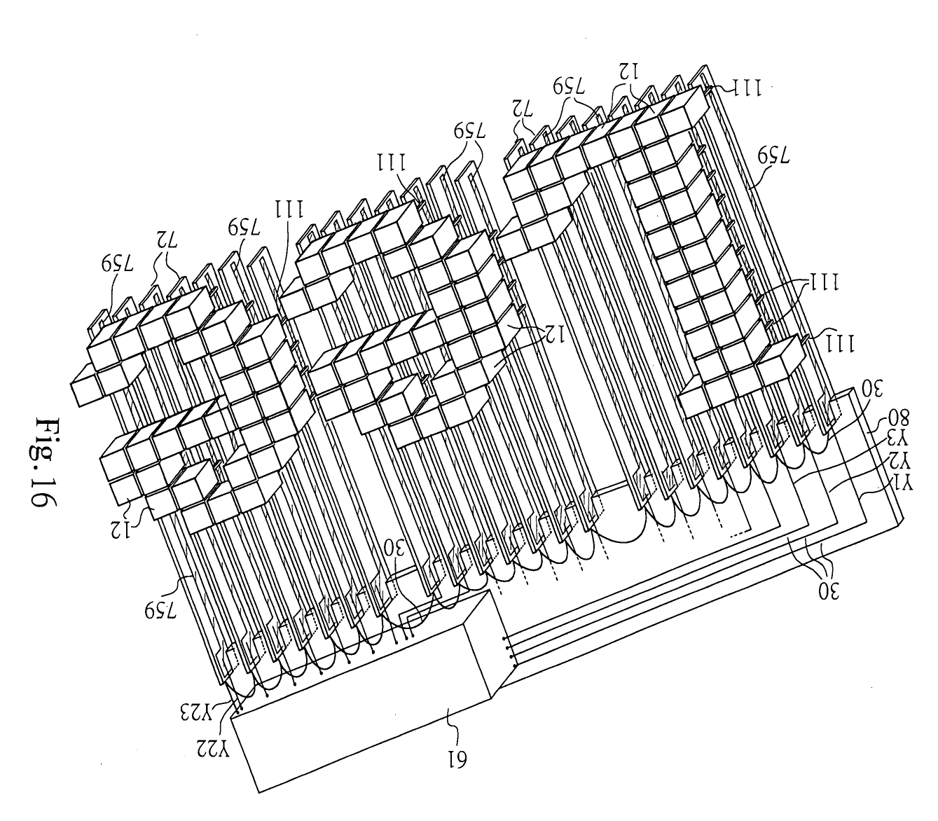

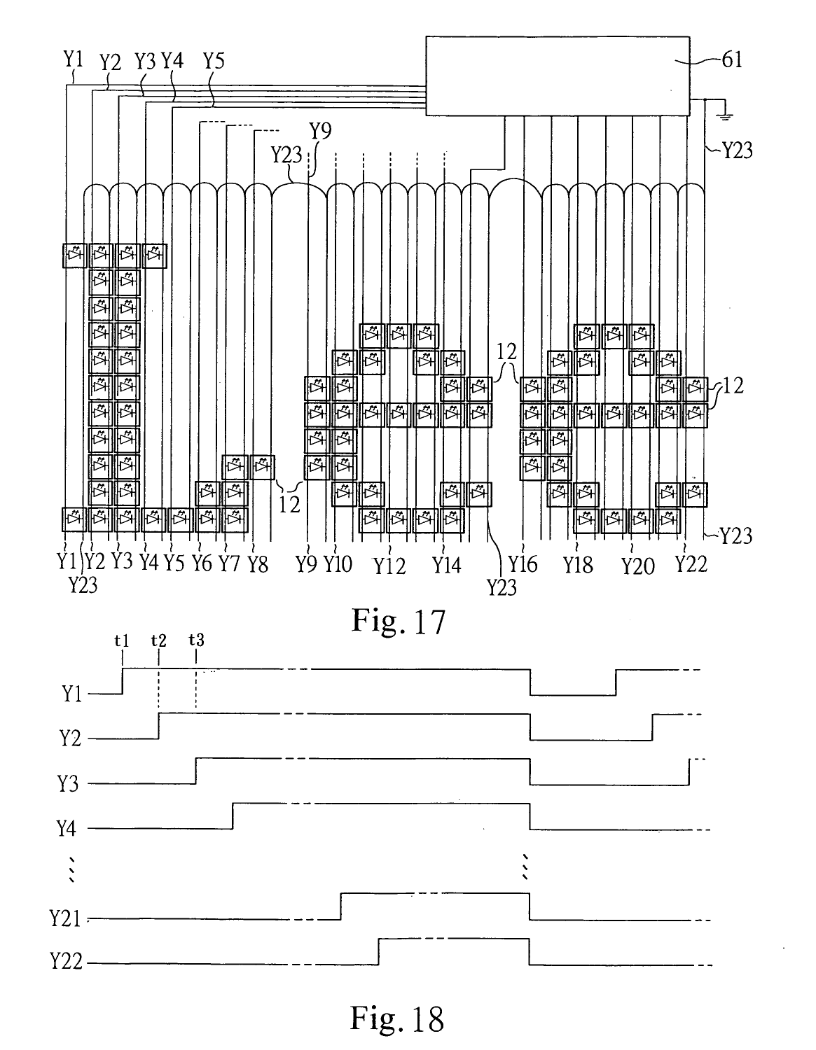

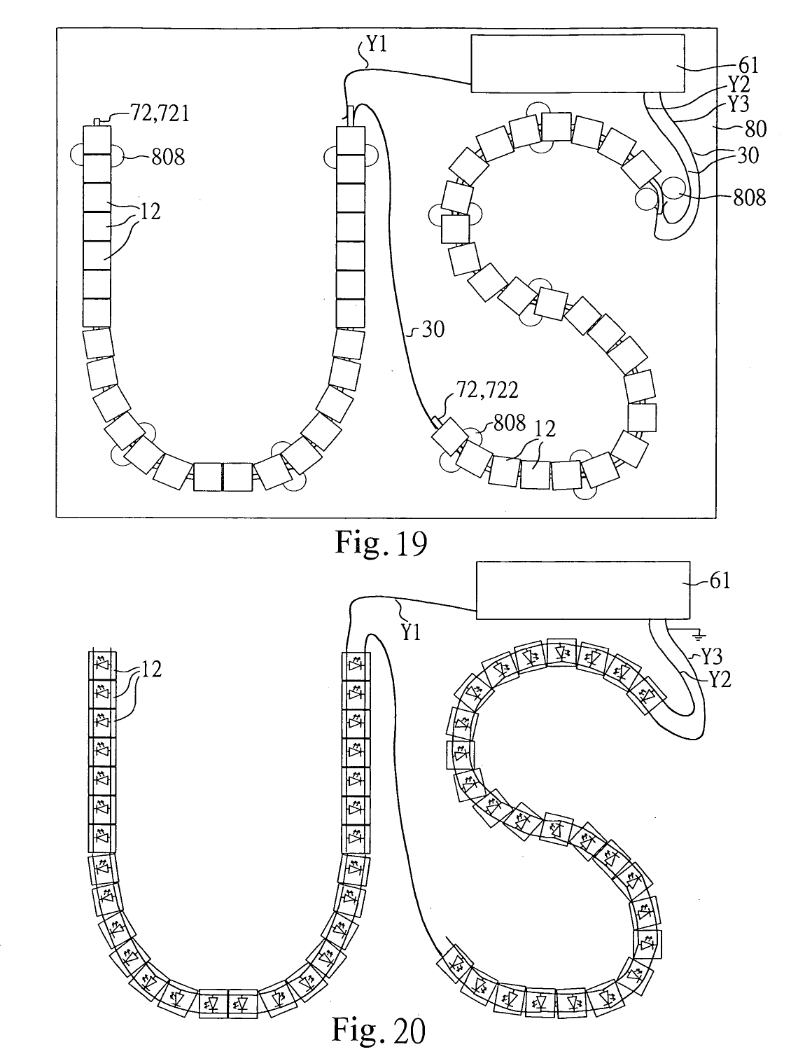

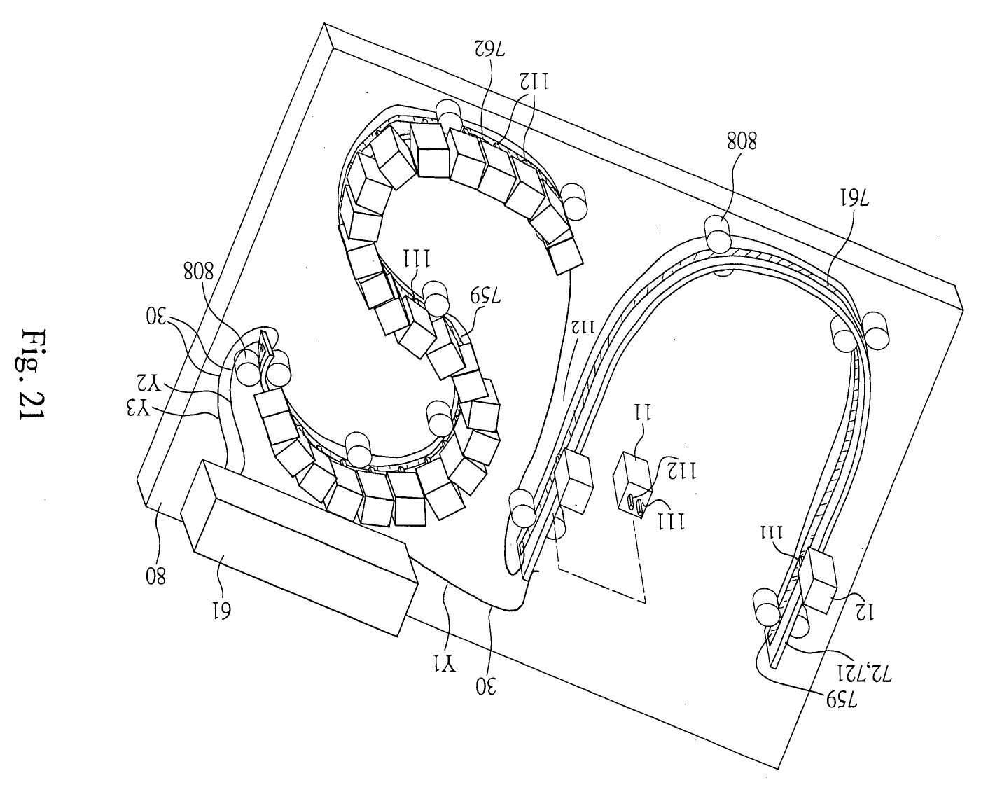

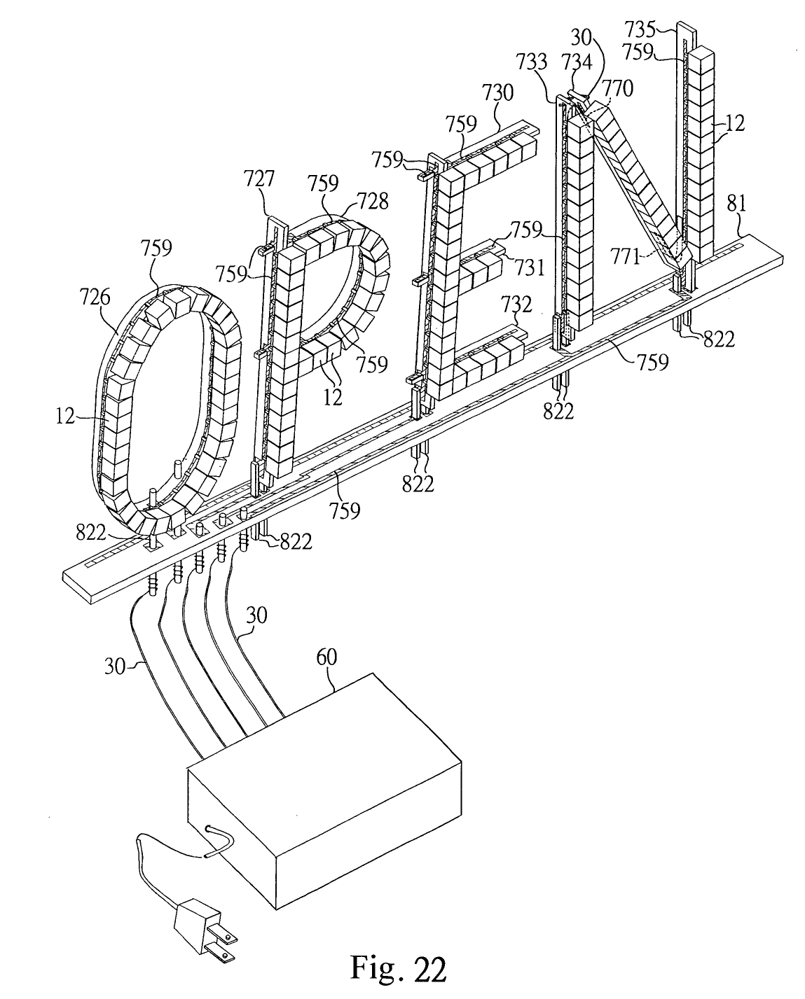

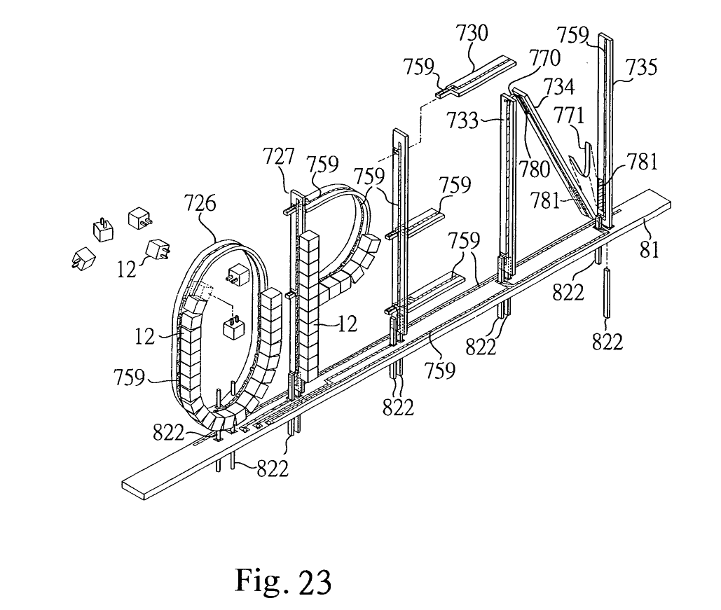

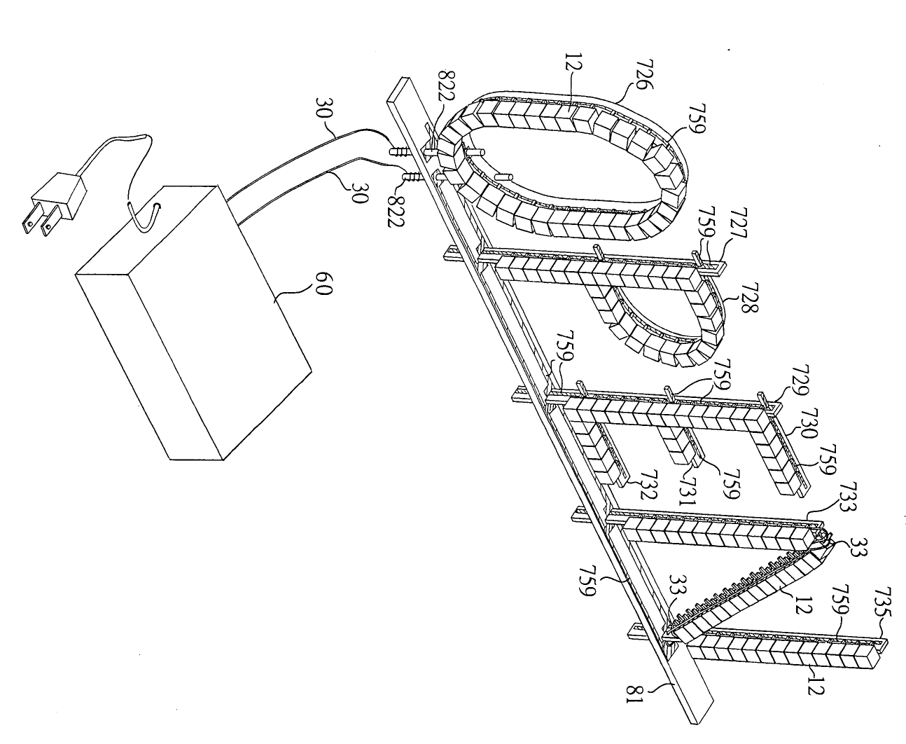

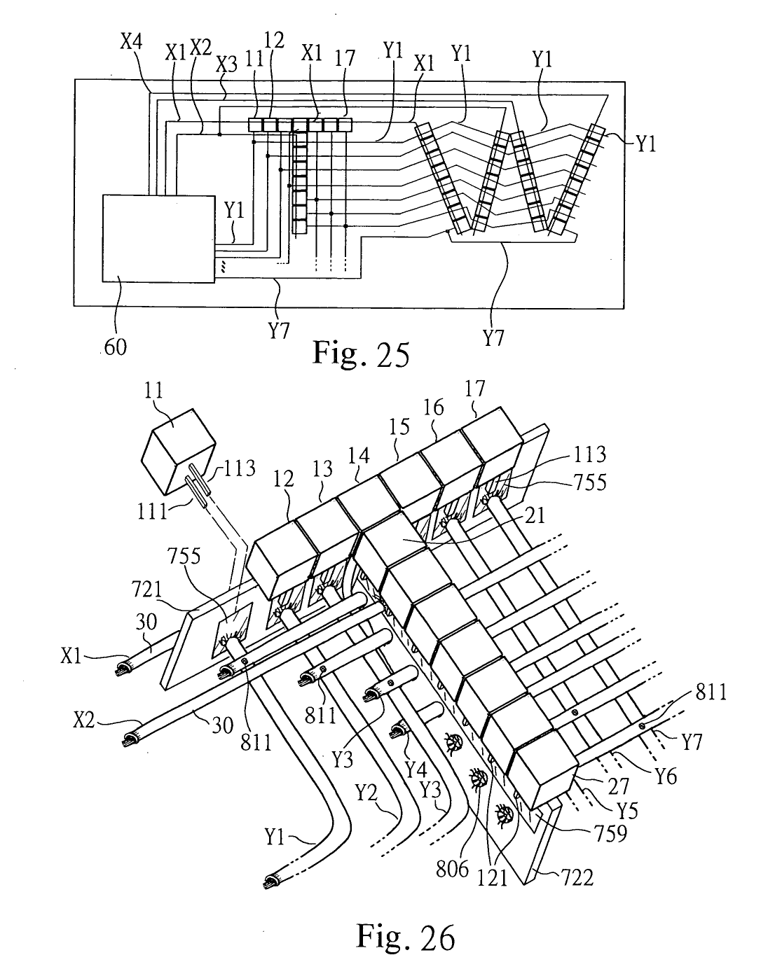

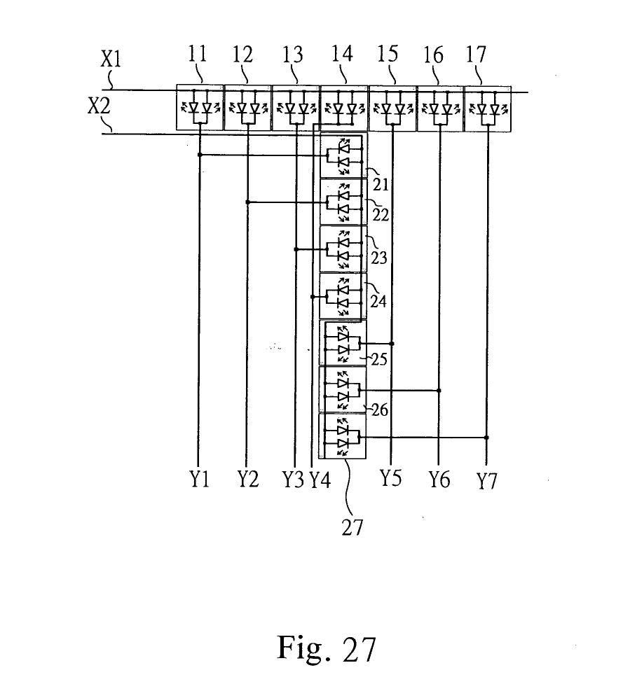

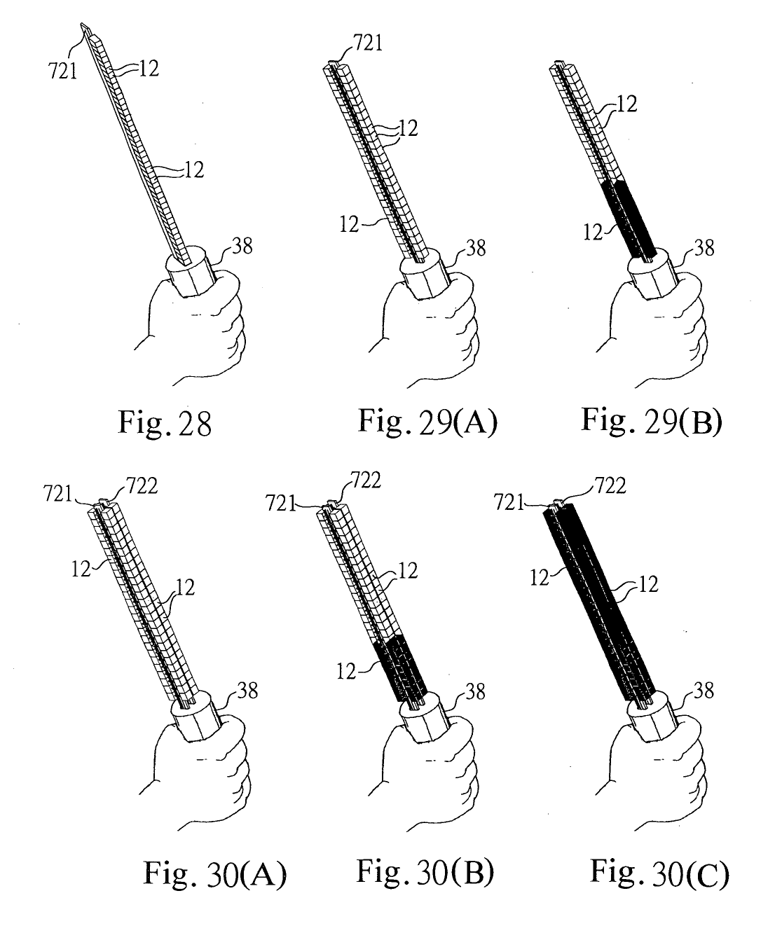

The LED lamp in the present invention is LED lamp or LED LIGHT BAR. Please refer to FIGS. 1(A), 1(B), 1(C) and 1(D) for those shaped in 6-face cuboid or cube. FIG. 1(A) shows a stereogram view, planform view, side elevation view and equivalent circuit diagram of the monocolor LED lamp with 2 pins, FIG. 1(B) representing a planform view, side elevation view and equivalent circuit diagram of the two fundamental colors LED lamp with 2 pins, FIG. 1(C) relating to a planform view, side elevation view and equivalent circuit diagram of the two fundamental colors LED lamp with 3 pins and FIG. 1(D) relating to a planform view, side elevation view, another side elevation view, luminescent area planform view and equivalent circuit diagram of LED Light Bar. FIGS. 2(A),2(B),2(C) and 2(D) show a front elevation view, side elevation view and equivalent circuit diagram of LED lamps for those shaped in cylinder, LED lamps with 2 pins in FIG. 2(A) and 2(B), the monocolor LED lamp in FIG. 2(A) and the two fundamental colors (RY) LED lamp with 2 pins in FIG. 2(B). All embodiments of the monocolor LED lamps with 2 pins of the present invention can be improved as the two fundamental colors LED lamps in FIG. 2(B) with the driving circuit to develop into multiple colors display. FIG. 2(C) relates to the two fundamental colors (RG) LED lamps with 3 pins and FIG. 2(D) relates to the three fundamental colors (RGB) LED lamps with 4 pins. In accordance with the cross between multiple column electrodes and multiple row electrodes and the installation method of LED lamps at numerous pixel points, the embodiments vary with the difference of the voltage driving method. FIG. 3 relates to a plan view of the monocolor LED lamps mounted on partial pixel points and FIG. 4 shows a plan view of the monocolor LED lamp mounted on all pixel points. Partial installation of the monocolor LED lamp in FIG. 3 displays an English word of “Lee”. Besides, drive circuit 60 adopts the addressing and selection method of the dot matrix array of LED lamp, the long PCB 72, the shape of copper foil in PCBs and the installation method of LED lamp 12 are identical. Based on all installations, the description in details is provided with drawings as follows: FIG. 5 is a perspective view of LED dot matrix array; FIG. 6 is a perspective view of LED dot matrix array for assembling and FIG. 7 is a perspective view of LED dot matrix array in reversed side. Numerous long PCBs 72 insert into frame 80 vertically, pole 820 inserted into eyelet 805 with 3 screws 811 fixing. The long PCBs 72 are provided with single-surface copper foillayer, the copper foillayer hereof etched into long copper foil tape 753 and short copper foil tape 754, all LED lamps straddling over each long PCB 72 and numerous LED lamps 12 straddling over edges of long PCB 72, cathode pin 112 connected with and soldered to long copper foil tape 753. Hereby, long copper foil tapes 753 of each long PCB 72 generate column electrode Y1, Y2 and Y3, etc, while anode pins 111, 211, etc are placed at the side of the copper foil free of long PCB 72, all the LED lamps arranged in the first column which anode pins 111 are soldered to thick copper wire 701 to generate row electrode X1, thick copper wire 701 with thin copper wire 901 threaded into eyelet 806 on long PCB 721, then soldered to short copper foil tape 754 so that row electrode X1 is transferred to short copper foil tape 754, all row and column electrodes connected by long and short copper foil tape 753 and 754, then connected to the drive circuit 60 by electric wire 30. FIG. 8(A) is an assembly stereogram view of single-surface monocolor display of another embodiment and FIG. 8(B) relates to an equivalent circuit diagram of single-surface monocolor display of the embodiment. Both surfaces of long PCB 72 are embedded with copper foil, multiple copper foil rectangles 755 lined at one surface and multiple comb copper foils 760 provided at another surface, each copper foil rectangle 755 punctured with a eyelet 806, 4 long PCBs of PCB 721, 722, 723 and 724 installed with numerous LED lamps 12 and lined parallelly, the long PCB 721 moved right to close to other three long PCBs with dot matrix array, LED lamps 12 straddling over long PCB 72, cathode pin 112 soldered to copper foil rectangle 755 and anode pin 111 soldered to comb-shaped copper foil 760. Numerous thick copper wires 70 are threaded into eyelets 806 on copper foil rectangle 755 in the same row, soldered to copper foil rectangle 755. The function of thick copper wires 701 is to transfer copper foil 758 of row electrode X1 in long PCB 721 to the column direction, while the function of thick copper wires 702 is to transfer copper foil 758 of row electrode X2 in long PCB 722 to the column direction, the others on the analogy of this. FIG. 9(A) relates to an assembly stereogram view of the embodiment for double-surface monocolor display and FIG. 9(B) shows a equivalent circuit diagram of the embodiment for double-surface monocolor display. The long PCBs 72 are provided with double-surface copper foil, four PCBs of PCB 721, 722, 723 and 724 lined vertically, copper foil rectangles 755 lined in pairs at the left side with eyelet 806 and the dendritic-shaped copper foil 756 provided at right side. LED lamps 12 are installed at the front side and LED lamps 12b are installed at the back side, all of which straddling over the edges of long PCBs 72. Cathode pin 112 at the left side of long PCBs 72 is placed in and soldered to copper foil rectangle 755, while anode pins 111 at the front and back side of LED lamps 12 and 12b in the same row are at the right side. Dendritic-shaped copper foils 756 are soldered in proper place to generate column electrode, such as, column electrode Y5 of long PCB 725 as seen in the FIG. 9(A). Thick copper wire 701 is threaded into eyelet 806 of copper foil rectangle 755 to connect with cathode pin 112 of the front LED lamp 12 at the front row, then soldered to generate row electrode X1 in the front. Then it is transferred to the column direction through copper foil line 758 of long PCB 721, the drive circuit (without marking out) connected by electric wire 30. row electrode X1b is connected by thick copper wire 702 with cathode pin of LED lamps 12b installed at back side in the first row. FIG. 10 relates to a perspective view for assembly of the first embodiment for single-surface two fundamental colors display. LED lamps 12 is provided with 3 pins for 2 fundamental colors common anode display with red and green. 3 pins are placed at the same surface of long PCB 72, siding over the edges of long PCB 72, such as LED lamps 64 siding over long PCB 724, red cathode pin 641 and green cathode pin 643 thereof connected with and soldered to copper foil rectangle 755, common anode pin 642 bent and threaded into eyelet 807 to copper foil tape 759 at the back side, then soldered (i.e. long PCB 725 shown in FIG. 10 ), each copper foil tape 759 to generate column electrode Y1, Y2 and Y3, etc (no marking out). Thick copper wire 70 is threaded into the eyelet 806 of the red cathode pin or the green cathode pin in the same row of each copper foil rectangle 755, then soldered to generate the red row electrode or the green row electrode X1R, X1G, X2R and X2G, etc, then it is connected in the column direction by copper foil lines 758, such as the red row electrode X1R and the green row electrode X1G connected by copper foil wire 758 of long PCB 721 and the red row electrode X2R and the green row electrode X2G connected by copper foil wire 758 of long PCB 722, the others on the analogy of this. FIG. 11 relates to a perspective view for assembly of the second embodiment for single-surface two fundamental colors display. The difference between this embodiment and the first embodiment in FIG. 10 is long PCBs 72 with single-surface copper foil and LED lamp 12 is the two fundamental colors display resulting in 3 copper foil rectangles 755 must be provided with 3 pins. Each long PCB 72 provides 3 copper foil tapes 758, one for column electrode, one for row red electrode and the other for green row electrode. Jumper wires 780 and 781 must be provided. Please refer to FIG. 12 is a perspective view for assembly of the embodiment for double-surface two fundamental colors display, LED lamps 12 and 12b at the front and back sides with 3 pins for the two fundamental colors common anode of red and green siding over the edges of long PCBs 72. The red cathode pin of LED lamps 12 at the front side in the first row is connected by thick copper wire 701 and the red cathode pin of LED lamp 12b at the back side in the first row connected by the thick copper wire 702, then transferred by copper foil line 758 of long PCB 721 to the red row electrode X1R. In the same column and at the same surface of each long PCB, the common anode pin of LED lamps appears. After threading into the eyelet of PCB 72 and soldered to copper foil tape 759, the column electrode is generated, such as 2 copper foil tapes 759 on the long PCB 726 for Y6 and Y6b, as seen in FIG. 12. FIG. 13 shows an equivalent circuit of the embodiment, LED lamps 11, 21 and 31 for display of the first column at the front side and LED lamps 11b, 21b and 31b for display of the first column at the back side, the others on the analogy of this. LED lamps installed in the same row and side are connected with the red cathode pin to generate the red row electrode X1R, X2R and X3R, etc and connected with the green cathode pin to generate green row electrode X1G, X2G and X3G, etc. With proper drive signal, the luminescence color of each LED lamp can be selected for the red or green. Please refer to FIG. 14 for timing diagram of the drive voltage. clk is the frequency wave signal. every k cycles is a time period (T). The interior cycles are named with Ts1, Ts2 . . . Tsk. Within every time period (T), the column electrode Y1 can reach high potential (H) only at Ts1 and the column electrode Y1b can reach high potential (H) only at Ts2 and the column electrode Y2 can reach high potential (H) at Ts3, the others on the analogy of this. Within every time period (T), H or L of the interior row electrode X1R and X1G at Ts1 drive LED lamp 11 at the front side in red, green, orange or off (L refer to lightup) due to the transient phenomena of the human eyes, and H or L at Ts2 drive LED Lamp 11b at the back side in red, green, orange or off (L refer to lightup), the others on the analogy of this. Through observation of the timing voltage of the row electrode X1R and X1G, provided that are H during Ts1 within every time period (T), LED lamps at the front side are off, and if X1R and X1G are L during Ts2 within every time period (T), the two fundamental colors of the red and green for LED lamps 11b at the back side are on to display in orange. Within every time period (T), X1R is L at Ts3, and H at X1G, and the red chip of LED Lamp 12 at the front side is on to display in red. Refer to FIG. 15 for a stereogram view of the embodiment for the curved side monocolor display. It adopts multiple arcing ring Printed Circuit Boards 73 (referred to as arcing ring PCB 73) with double surface copper foil so that the faces are arranged parallelly with equal distance. Multiple copper foil rectangles 755 are soldered to anode pins 111 of LED lamps 12 at one surface. At another surface, the copper foil tapes are soldered to the cathode pins of LED lamps 12 to generate the column electrode (no marking out). Each thick copper wire 70 is threaded into the eyelet of copper foil rectangle 755 in the same column and then soldered to produce column electrodes Y1, Y2 . . . Y25, etc. The row and column electrodes are generated with the drive circuit 60 by electric wire 30. Applying the dot matrix voltage driving signals, it can address and select any LED lamp for lightup and display. Please refer to FIG. 16 for a stereogram view of the first embodiment for display of the fixed text. It adopts multiple long PCBs 72 with copper foil lines 759 being etched in double surfaces, the surfaces upright and parallel and fastened to frame 80, multiple LED lamps 12 straddling over long PCB 72 as the shape of letter of “Lee”. Anode pins 111 of LED lamps 12 in the same column straddling over the copper foil line 759 at the left surface of long PCBs 72 and soldered to fasten and connect, in order to produce the electrode, such as Y1, Y2, Y3 . . . Y22, etc, cathode pins in the same row straddling over the copper foil line at the right surface (no marking out), then electric wire 30 adopted to connect and solder to generate column electrode Y23, connected to the common reference potential of square wave 61 (earthing), which provides the periodic square wave drive voltage for each column electrode of Y1, Y2, Y3 . . . Y22, etc. Please refer to FIG. 18 for the voltage timing diagram to drive the equivalent circuit diagram of the first embodiment for display of the fixed text shown in FIG. 17. The word of “Lee” is transformed to 22 rows and the lamps are on orderly from left to right till all lamps are on recurrently. FIG. 19 shows planform view of the second embodiment for display of the fixed text. FIG. 20 is an equivalent circuit diagram of the second embodiment for display of the fixed text. FIG. 21 is an assembly stereogram view of the second embodiment for display of the fixed text, the long PCBs 72 with double surface copper foil lines 759 bent and curved into 2 English letters of “US” along the clearance between 2 fixing poles 808, thickness and excellent winding, LED lamps 12 straddling over U-shaped long PCB 721 and its anode pins 111 soldered to copper foil lines 759, connected to generate electrode Y1. For S-shaped LED lamps 12, anode pins 111 are soldered to copper foil lines 759, connected to generate electrode Y2. For US-shaped LED lamps 12, anode pins 112 are soldered to copper foil lines 761 and 762, connected to generate electrode Y3 for the common reference potential (earthing). With periodic square wave for electrodes Y1 and Y2, the letters of U and S are flashing or on or off at the same time. FIG. 22 is a stereogram view of the third embodiment for display of the fixed words. FIG. 23 is an assembly stereogram view of the third embodiment for display of the fixed words, copper foil line 759 are embedded in numerous long PCBs 72 at both surfaces to form “OPEN”, among which, “O” is shaped by bending the long PCB 726, “P” shaped by puncture of 2 eyelets on long PCB 727 and bending two ends of long PCB 728, then inserted into 2 rabbets, “E” shaped by the rabbets of the long PCBs 730, 731 and 732 inserted into three eyelets on long PCB 729, then soldered to the copper foil face at the eyelet, and “N” shaped by three long PCBs 733, 734 and 735 and 2 V-shaped copper sheets 770 and 771 soldered in the retained copper foil area, such as V-shaped copper sheets 771 soldered to the copper foil rectangles 780 and 781. Four letters of “OPEN” are fixed on platform 81 with the bar coppers 822 soldering the copper foil lines 759 of long PCBs. FIG. 24 is a stereogram view of the fourth embodiment for display of the fixed words, the sloping line of Letter “N” in “OPEN” composed of 2 bare copper wires 33 soldered to several LED lamps 12. Please refer to FIG. 25, 26 and 27 for a planform, a partial stereogram view and an equivalent circuit diagram of the embodiment for display of the fixed word of “TW” with dot matrix voltage. “LED” lamps used are monocolor luminescences with 2 LED chips. For Letter “T”, adopt two long PCBs 721 and 722, Letter “W” adopting 4 long PCBs. The anode pins 121 of LED lamp 21 to 27 are soldered to the copper foil tape 759 to generate the row electrode X2 and LED lamp 11 is soldered to the anode pin of LED lamp 17 to generate the row electrode X1. The anode pin 113 of 14 LED lamps are soldered to the copper foil rectangle 755 with electric wire 30 and screws 811 to generate 7 colunm electrodes of Y1, Y2 . . . Y7. The row and column electrodes are connected with the drive circuit 60 with the dot matrix drive voltage signal to address and select any LED lamp for lightup and display. FIG. 28 shows a stereogram of a baton of the embodiment, characteristically of numerous LED lamps 12 straddled over and soldered to the long PCB 721 to form a straight segment. Then the Handle 38 is provided with the drive circuit. FIG. 29(A) relates to numerous LED lamps 12 installed at the front and back edges of PCB 721. And FIG. 29(B) shows a stereogram view of the second baton of the embodiment for lightup and display. FIG. 30(A) relates to numerous LED lamps 12 installed at 2 long PCBs 721 and 722 for double straight segments. And FIG. 30(B) shows a stereogram view of the third baton of the embodiment for lightup and display. FIG. 30(C) relates to a stereogram of the third baton of the embodiment for all lamps lightup and display. The common part of “electric wire 30” in above each figure is covered with the insulation layer to connect other parts through soldering or winding. The pins of LED lamps and the thick copper wire 70 are contiguous to the copper foillayer are connected through soldering with soft soldering for the copper foil. It is difficult to mark with icon, therefore all of them are described with words.

1. A LED display device comprising:
a plurality of pieces of long printed circuit boards (PCBs) or one piece;
numerous LED lamps siding or straddling over the edges of said long PCBs;
a LED drive circuit;
the pins of said LED lamps are soldered to the copper foil of said long PCBs to be integrated into a display unit with multiple LED lamps, after connection with the drive circuit, texts and images are displayed when said drive circuit voltages apply.

2. A LED display device as recited in claim 1, wherein the surfaces of said long PCBs being arranged vertically and parallelly with equal interval, where line-shape and other shape are etched from copper foillayers may generate the column electrodes and row electrodes; at numerous pixel points of cross between the row and column electrodes, LED lamps are installed on the long PCBs, siding or straddling over the edge of the said long PCBs; said LED lamps in the same column must have the pins, which are connected to generate the column electrode by soldering to a line-shaped copper foil; said LED lamps in the same row must have pins, which are connected to generate the row electrodes by being soldered to a plurality of long-shaped metal rods; after connection with the drive circuit, it can address and select any said LED lamp for lightup and display with the dot matrix voltage signals; Installation of said LED lamp means it is installed at pixel point, the said display unit either all pixel points being installed said LED lamps or part pixel points being installed said LED lamps.

3. A LED display device as recited in claim 2, wherein said long-shaped metal rod adopt the copper wire, and said long PCBs with single-surface copper foillayer, which are etched into copper foil tapes; The monocolor LED lamps with 2 pins straddle over the edge of said long PCBs, one pin of said LED lamps in the same column soldered to the copper foil tape for the column electrode and another pin of LED lamps in the same row soldered to the copper wire for the row electrode.

4. A LED display device as recited in claim 2, wherein said long-shaped metal rods adopt copper wire, the long PCB with single-surface copper foillayer, which are etched into multiple copper foil rectangles and copper foil tapes , each copper foil rectangle with eyelets; monocolor LED lamps with 2 pins or the two fundamental colors LED lamps with 3 pins siding over the edge of the said long PCBs, all pins at the copper foillayer side of said long PCB; and one pin of each LED lamp is soldered to the copper foil tape for the column electrode, other pins soldered to the copper foil rectangle, and the pins of the LED lamps in the same row are soldered to the copper foil rectangle after the said copper wire is threaded into said eyelet to be connected for the row electrode.

5. A LED display device as recited in claim 2, wherein said long-shaped metal rods adopt copper wires, long PCBs with double-surface copper foillayer, which being etched into the copper foil tapes for one surface and into numerous copper foil rectangles for another surface, and eyelets being provided for each copper foil rectangle; The monocolor LED lamps straddle over the edge of the said long PCB, which one pin in the same column is soldered to the said copper foil tape, other pins soldered to the copper foil rectangle and the pins of the LED lamp in the same row are soldered to the said copper foil rectangle after the said copper wire is threaded into said eyelets to be connected for the row electrode.

6. A LED display device as recited in claim 5, wherein the said monocolor LED lamps straddle over the double edges of each said long PCB become 2 columns, one pin of each LED lamp thereof soldered to the said copper foil tape to generate the column electrode, other pins soldered to the said copper foil rectangles, and the pins of the LED lamps in the same row soldered to the said copper foil rectangle after the said copper wire is threaded into said eyelets to be connected for the row electrode; and partial or all long PCBs being re-etched into copper foil line to transfer the row electrode to the column direction after the said thick copper wire is soldered to the said copper foil line.

7. A LED display device as recited in claim 2, wherein said long-shaped metal rods adopt copper wires, the long PCB with double-surface copper foillayer, which being etched into the copper foil tape for one side and into numerous copper foil rectangles for another side, eyelets provided for each said copper foil rectangle; and the monocolor or the two fundamental colors LED lamps siding over the edge of said long PCB, all pins placed at the same side and one pin not touching the said copper foil rectangle, the hook of the eyelet transversing from the said copper foil tape at another side to generate the column electrode; and the pins of the LED lamps in the same row in the said copper foil rectangles are soldered to the said copper foil rectangle after the said copper wire is threaded into said eyelet to generate the row electrode.

8. A LED display device as recited in claim 7, wherein the two fundamental colors LED lamps side over the double edges of each said long PCB become 2 columns, one pin of each said LED lamp in the same column is soldered to the said copper foil tape at another side through a eyelet to generate the column electrode, and the pins of each LED lamp in the same row at front and back edges are soldered in the said copper foil rectangle with the said copper wire threaded into the said eyelet to generate the row electrode.

9. A LED display device as recited in claim 2, wherein the said display unit is part pixel points being installed led lamp, is shaped into words or patterns.

10. A LED display device as recited in claim 2, wherein said multiple long PCBs are shaped into arcing ring and the said long-shaped metal rods adopt copper wire to form bend plane.

11. A LED display device as recited in claim 1, wherein the faces of multiple said long PCBs are arranged vertically and parallelly with equal interval, PCBs thereof with copper foil tapes; said LED lamps straddling or siding over the edges of the multiple said long PCBs in columns; and said LED lamps installed shaped into words or patterns may be displayed if the copper foil of each long PCB is soldered to the pins of LED lamp to generate directly electrode with the drive circuit.

12. A LED display device as recited in claim 1, wherein one or multiple long PCBs with bent or not bent boards comprise a display unit, which are shaped into words or patterns.

13. A LED display device as recited in claim 12, wherein the connection of some said long PCBs is to be etched into a copper foil rectangle on both neighboring said long PCBs, and to take a copper sheet being soldered to 2 copper foil rectangles at both ends.

14. A LED display device as recited in claim 12, wherein LED lamps are integrated into a display unit, partial display fractions comprising of soldering of numerous LED lamps by copper wires.

15. A LED display device as recited in claim 12, wherein the integration of a display unit displays the geometric figures.

16. A LED Display Device as recited in claim 15, wherein the integration of a display unit displays the linear portion.

17. A LED display device as recited in claim 12, wherein the copper foillayer of long PCBs being etched into multiple copper foil rectangles, lines or tapes, multiple said LED lamps densely straddle over the edges of each long PCB; the pins of LED lamps connected with the same copper foil tape are soldered to generate the colunm electrode, other pins of LED lamps soldered in the connected copper foil rectangle, then numerous rectangles integrated with the electric wires to generate the row electrode; after the row and column electrodes are connected to the drive circuit with the dot matrix voltage signals, it may address and select any LED lamp for display.
